(19) United States
(12) Patent Application Publication
(10) Pub. No.: US 2014/0300503 A9
(43) Pub. Date: Oct. 9, 2014

(54) MILLIMETER WAVE ENERGY SENSING WAND AND METHOD

(71) Applicant: Robert Patrick Daly, Orlando, FL (US)

(72) Inventor: Robert Patrick Daly, Orlando, FL (US)

(73) Assignee: MICROSEMI CORPORATION, Aliso Viejo, CA (US)

(21) Appl. No.: 13/565,598

(22) Filed: Aug. 2, 2012

Related U.S. Application Data
(63) Continuation-in-part of application No. 13/019,722, filed on Feb. 2, 2011.
Application No. 13/019,722 is a continuation-in-part of application No. 12/338,807, filed on Dec. 18, 2008, now Pat. No. 8,437,566.
(60) Provisional application No. 61/014,692, filed on Dec. 18, 2007.

(51) Int. Cl. G01S 13/88

(52) U.S. Cl. 342/22

(57) ABSTRACT

A millimeter wave energy sensing wand includes a housing adapted to be grasped by a hand of an operator. A number of sensors may be coupled with the housing and include comprising at least one millimeter or terahertz wave energy sensor. A controller coupled with the housing and electrically coupled with the sensors receives signals from the sensors in two or more sensing modes, including an active sending mode and a passive sensing mode, and generates feedback when an anomaly is detected in the received signals. The sensors may also operate in a metal detection sensing mode, and the controller may further generate feedback based on the metal detection sensing mode. The sensors may further be configured to operate in a proximity sensing mode. One or more LEDs may illuminate a portion of a scanning area.

### CROSS-REFERENCE TO RELATED APPLICATIONS

This application is a continuation-in-part of U.S. patent application Ser. No. 13/019,722 entitled “MILLIMETER WAVE ENERGY SENSING WAND AND METHOD,” and filed on Feb. 2, 2011, the entire disclosure of which is incorporated herein by reference.

### FIELD

The present disclosure relates in general to the field of concealed object detection systems using millimeter wave energy, and in particular to a handheld millimeter wave energy sensing wand and method.

### BACKGROUND

A passive millimeter wave camera has the ability to detect and image objects hidden under clothing using millimeter wave imagery. The passive millimeter wave (PMMW) sensors detects radiation that is given off by all objects. The technology works by contrasting the millimeter wave signature of the human body, which is warm and reflective, against that of a gun, knife or other contraband. Those objects appear darker or lighter because of the differences in temperature, hence, millimeter wave energy, between the human body and the inanimate objects.

While the expanded use of whole body imaging (WBI) systems provides increased security at airports, it creates a problem for secondary screening, because metal detector wands may not be able to detect non-metallic objects found by the WBI systems. Therefore, time-consuming and invasive physical pat downs may be required, and/or the subject can be iteratively sent back through the WBI to clear alarms. Either approach may result in slower throughput at security checkpoints.

A secondary screening sensor that is matched to a primary screening sensor technology may be desirable, however, the deployment of X-ray backscatter and/or an active millimeter wave (MMW) imaging systems makes this problematic. A handheld X-ray wand is not practical due to size, weight and power (SWAP) considerations. Furthermore, relying on an image-based sensor for secondary screening, which may help alleviate false alarms, may exacerbate privacy concerns and/or may prevent thorough screening over all parts of the body.

Harsh and uncontrolled environments can affect the operation of WBI systems that must be adapted for each installation to provide the proper contrast between the environment and a subject so that the PMMW sensors can detect concealed objects, which is expensive and time consuming. Further, personnel must be trained to operate the system for each different installation environment. Additionally, WBI systems are dependent on existing utilities and on-site support, which may not always be available in a harsh environment.

### SUMMARY

Methods, systems, and devices for concealed object detection are provided, which may operate in two or more operating modes using a handheld detection apparatus. Operating modes may include passive millimeter wave detection mode, active millimeter wave detection mode, and a metal detection mode. A number of sensors may be coupled with the housing and include comprising at least one millimeter or terahertz wave energy sensor. A controller coupled with the housing and electrically coupled with the sensors receives signals from the sensors in two or more sensing modes, including an active sending mode and a passive sensing mode, and generates feedback when an anomaly is detected in the received signals. The sensors may also operate in a metal detection sensing mode, and the controller may further generate feedback based on the metal detection sensing mode. The sensors may further be configured to operate in a proximity sensing mode. One or more LEDs may illuminate a portion of a scanning area.

In some embodiments, novel functionality is provided for a concealed object detection apparatus. The apparatus of a set of embodiments includes a housing comprising a handle adapted to be grasped by an operator to facilitate movement of the housing to a sensing area on a body. A number of sensors are coupled with the housing including at least one millimeter or terahertz wave energy sensor. A controller may be coupled with the housing and electrically coupled with the plurality of sensors. The controller, according to embodiments, receives signals from the plurality of sensors in two or more sensing modes, including an active sending mode and a passive sensing mode, and generates feedback when an anomaly is detected in the received signals.

In other embodiments, novel functionality is provided for a method for concealed object detection with a handheld detector. The method includes receiving millimeter or terahertz wave energy emissions from a body. A background value of millimeter or terahertz wave energy emissions of the body is determined. A millimeter or terahertz wave energy source is activated to irradiate a sensing area of the body, and millimeter or terahertz wave energy emissions are received from the sensing area. The background value and the millimeter or terahertz wave energy emissions are compared, and feedback may be generated when the comparing indicates an anomaly in the millimeter or terahertz wave energy emissions at the sensing area.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the spirit and scope of the appended claims. Features which are believed to be characteristic of the concepts disclosed herein, both as to their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the present invention may be realized by reference to the following drawings. In the appended figures, similar components or features may have the same reference label.

FIG. 1 is a front perspective view of a millimeter wave energy sensing wand of an embodiment;

FIG. 2 is a rear perspective view of a millimeter wave energy sensing wand of an embodiment;

FIG. 3 is a front perspective view of a millimeter wave energy sensing wand of an embodiment shown without a housing;

FIG. 4 is a side perspective view of a millimeter wave energy sensing wand of an embodiment shown without a housing;

FIG. 5 is a perspective view of the scanning area of a millimeter wave energy sensing wand of an embodiment;

FIG. 6 is diagram of scanning a body with the particular illustrative embodiment of a millimeter wave energy sensing wand;

FIG. 7 is a rear perspective view of a millimeter wave energy sensing wand of another embodiment;

FIG. 8 is a front perspective view of a millimeter wave energy sensing wand of another embodiment;

FIG. 9 is a bottom perspective view of a millimeter wave energy sensing wand shown without the housing;

FIG. 10 is a top perspective view of a millimeter wave energy sensing wand shown without the housing;

FIG. 11 is a perspective view of a millimeter wave energy sensing wand, illustrating a boundary of the associated scanning area;

FIG. 12 is a perspective view of a millimeter wave energy sensing wand illustrating a boundary of the associated scanning area;

FIG. 13 is diagram of scanning a body with a millimeter wave energy sensing wand of an embodiment;

FIG. 14 is an elevational view of a millimeter wave energy sensing wand of another embodiment;

FIG. 15 is a rear perspective view of a millimeter wave energy sensing wand of another embodiment;

FIG. 16 is a bottom perspective view of a millimeter wave energy sensing wand of another embodiment;

FIG. 17 is a top perspective view of a millimeter wave energy sensing wand of another embodiment;

FIG. 18 is a perspective shadow view of the of a millimeter wave energy sensing wand illustrating a configuration of internal components;

FIG. 19 is a perspective view of the of a millimeter wave energy sensing wand of an embodiment illustrating a boundary of the associated scanning area;

FIG. 20 is a diagram of scanning a body a millimeter wave energy sensing wand of another embodiment;

FIG. 21 is a flow diagram of an embodiment of a millimeter wave energy sensing method.

FIG. 22 is a graph indicating thermal dead-bands associated with passive millimeter wave detection systems.

FIG. 23 is a block diagram of a concealed object detection device according to embodiments.

FIG. 24 is an illustration of a circuit board and associated millimeter wave sensors.

FIG. 25 is a block diagram of a concealed object detection device according to some embodiments.

FIG. 26 is a block diagram of a concealed object detection device according to some other embodiments.

FIG. 27 is an illustration of a Frensel lens according to an embodiment.

FIG. 28 is a block diagram of a controller module for a concealed object detection device according to some embodiments.

FIG. 29 is a flow diagram of an embodiment of a millimeter wave energy sensing method.

### DETAILED DESCRIPTION

This description provides examples, and is not intended to limit the scope, applicability or configuration of the invention. Rather, the ensuing description will provide those skilled in the art with an enabling description for implementing embodiments of the invention. Various changes may be made in the function and arrangement of elements.

Thus, various embodiments may omit, substitute, or add various procedures or components as appropriate. For instance, aspects and elements described with respect to certain embodiments may be combined in various other embodiments. It should also be appreciated that the following systems, devices, and components may individually or collectively be components of a larger system, wherein other procedures may take precedence over or otherwise modify their application.

Various embodiments described herein provide a millimeter ways millimeter wave energy sensing wand, which may provide similar throughput as a metal detector (MD) wand approach, while enabling reliable detection of both non-metallic and metallic objects. Like the MD wand, the millimeter wave energy sensing wand may audibly alert the operator to concealed objects in real time. The millimeter wave energy sensing wand of various embodiments does not produce any imagery and can therefore be used over the entire body without causing any privacy concerns. High-probability detection may be achieved over all parts of the body at a scan rate of ˜1 m/s, according to embodiments. Minimal training is required because operation is similar to the current MD wand procedure. The millimeter wave energy sensing wand may be relatively light-weight (e.g., 2 lbs or less) and may operate on standard battery power for at least one full day before requiring a recharge. The wand may also be combined with any metal detector components and technology to provide additional efficacy in detecting metallic and non-metallic objects.

The millimeter wave energy sensing wand of some embodiments penetrates clothing to detect concealed objects, including plastics, metal, bulk explosives, liquids and gels. PMMW algorithms look for contrast anomalies between the background (human body) and concealed objects hidden under clothing. The human body naturally emits energy in the MMW band, and concealed objects block these emissions, producing a readily-detectable contrast when the body is scanned. The PMMW sensors (or pixels) of millimeter wave energy sensing wands of some embodiments do not provide the same image resolution as X-rays or active MMW radars, but there is no radiation threat, either for passengers or operators, and privacy issues are not a concern.

With respect to passive MMW detection, because the underlying detection phenomenology relies on receiving naturally-occurring MMW energy emissions from the human body (i.e., energy which would be blocked by concealed objects) rather than reflection of transmitted energy off concealed objects, which must be distinguished from complex reflections off the body, the detection algorithms of PMMW energy sensing wand modes operate on stable and predictable data.

In some embodiments, a range measurement device (e.g., proximity sensor) may be used at each pixel to ensure that measurements from the body are received rather than extraneous energy received at a pixel not positioned directly over the body. Such a proximity sensor helps ensure that pixels which are not positioned over the body are not included in the detection process. The proximity sensor may be an infrared sensor, for example, or signals from a MMW detector of a pixel, or adjacent MMW detectors, may be used to determine proximity. In addition, a scanning speed sensor may be included to check the speed at which the wand is being used to scan a body. A three-axis accelerometer may be used to determine an estimate of the scanning speed to convert to a frequency to filter the output. For example, if the scanning speed is determined to be 20 Hz, then any 20 Hz (+−) changes are filtered out as being the result of the wand moving at the scanning speed, and not a concealed object.

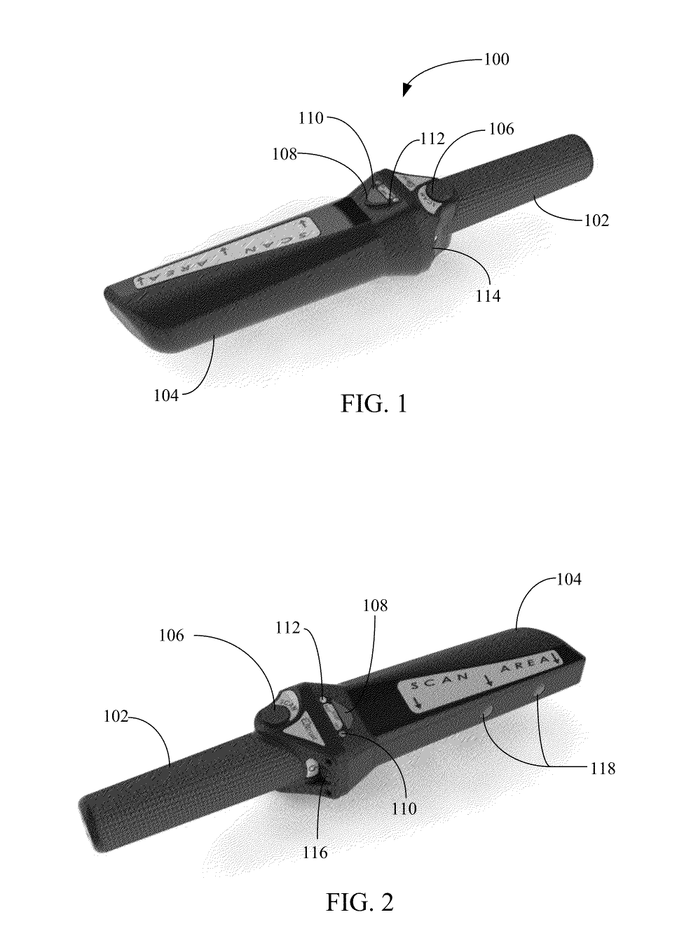

Referring now to FIGS. 1 and 2, a particular illustrative embodiment of a millimeter wave energy sensing wand is disclosed and generally designated 100. The wand includes a housing 104. The housing 104 is used to contain at least one pixel and other electronics for detecting and processing millimeter wave energy including energy above and below millimeter wave (e.g., terahertz). Accordingly, wherever the term “millimeter wave” is used herein, it is also intended to include electromagnetic waves propagating at different frequencies such as at least terahertz wave as well, and not limited to millimeter wave. For example, the pixel(s) are adapted to detect millimeter wave energy emissions and/or terahertz emissions. A handle 102 allows an operator to grasp the wand 100 and orient the wand 100 appropriately as it is passed over a body during scanning. A scan button 106 is pressed by the operator to activate the wand 100 and to begin receiving millimeter wave energy to determine whether a concealed object may be present on the body. An alarm is activated when an anomaly of the millimeter wave energy emissions is detected. A visual alarm light 108 (e.g., LED) may be illuminated when the alarm is triggered. A power or “on” light 110 is disposed on the housing 104 to signal to the operator that the wand 100 is active and ready to be used. If the wand 100 is being powered by a battery, then a low battery light 112 may be illuminated when the battery needs to be recharged, a new battery installed or the wand 100 should be connected to an external power source. A power button 116 is used to switch the wand 100 on. A conventional battery or a rechargeable battery (e.g., lithium polymer) may be contained within the housing 104 and may be recharged by direct contacts, plug-in cable or inductance. The wand 100 may be environmentally sealed with an IP66 rating.

A lanyard (wrist strap) may be secured to the wand 100 for carrying. A high density polyethylene (HDPE) plastic opening may be used to increase millimeter wave energy sensing if the ABS/PC plastic housing 104 (approx. 0.075″ thick) prevents penetration. A cut-out in the plastic housing 104 may be added and a piece of HDPE can be hermetically bonded to create an environmental seal or a gasket may be used. PCA mounting brackets and plastic bosses are used to secure the electronics within the housing 104.

A background millimeter wave energy value is determined using a moving average as the body is scanned. Thus, when the millimeter wave energy emissions vary by a predetermined range (i.e., anomaly) from the background value based on the moving average, the alarm is activated. Alternatively, prior to beginning a scan of the body, the wand 100 may be reset or zeroed using a reset button 114 on the wand 100 to provide a background millimeter wave energy value of the body based on an absolute value. The wand 100 may generate an audible alarm if any object is detected by the wand 100. This is similar to the current MD wand alarm generation approach. A more advanced approach may take advantage of the multiple detection channels within the millimeter wave energy sensing wand 100. For example, the presence of a proximity sensor in each measurement channel may allow a visual alert (via LEDs) for each measurement element. The audible alarm would sound based on selectable logic (e.g., alarm sounds if an object is detected at any pixel, or, alarm only sounds if M-of-N channels detect an object). Any channel that is not positioned over the body (as might happen when scanning over the arm or leg) would not be capable of generating or contributing to an audible alarm. An audible alarm with individual, channel-based LEDs may simplify the target localization process and speed alarm clearance. LEDs 118 of the millimeter wave sensing wand 100 may also be used to guide the screening process by illuminating an area that is being scanned upon scan activation, thus providing a visual indication of the particular area that is being scanned.

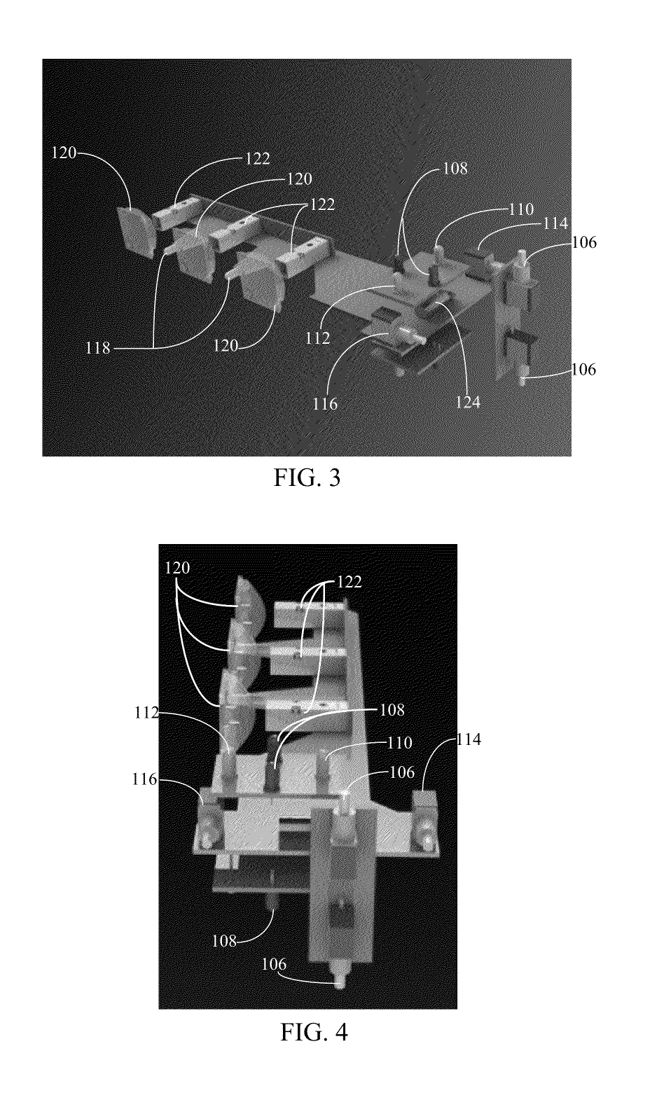

Referring now to FIGS. 3 and 4, lens(es) 120 of the millimeter wave energy sensing wand 100 allow for relatively rapid scanning of the diverse body part shapes such as the torso, arms and legs, while ensuring gap-free coverage for high probability detection (PD). The size of each lens 120 may be reduced considerably from WBI system lens sizes due to the reduced operating distance. Current WBI systems operate at a nominal 8 ft standoff, while the millimeter wave energy sensing wand 100 may operate at 6 inch standoff or less. This enables a reduction from the current 9 inch lens diameter to ˜0.5 inch diameter, while retaining the same signal-to-noise (S/N) ratio for detection, since range and aperture size are both present in the range equation as squared terms. A nominal 1 inch square lens 120 may be used to provide some detection margin.

In one embodiment, the wand 100 includes three pixels 122 and lenses 120. The pixels 122 are spaced about 2.0 inches apart. The lens 120 may be 1.0 to 2.0 inches square and offset 10 to 40 mm from the pixel horn depending on the particular application. The pixel spacing may be 2.0 inches apart. Separate pixels 122 (or modules) may be used for each receive element versus a multi-channel module, and the integration of the lens 120 or MMW antenna into the MMW module. The wand 100 may include a vibration motor 124 that is triggered by the alarm so that the operator can feel or sense when the wand 100 has detected an anomaly in the millimeter wave energy emissions, which may indicate a concealed object on the body.

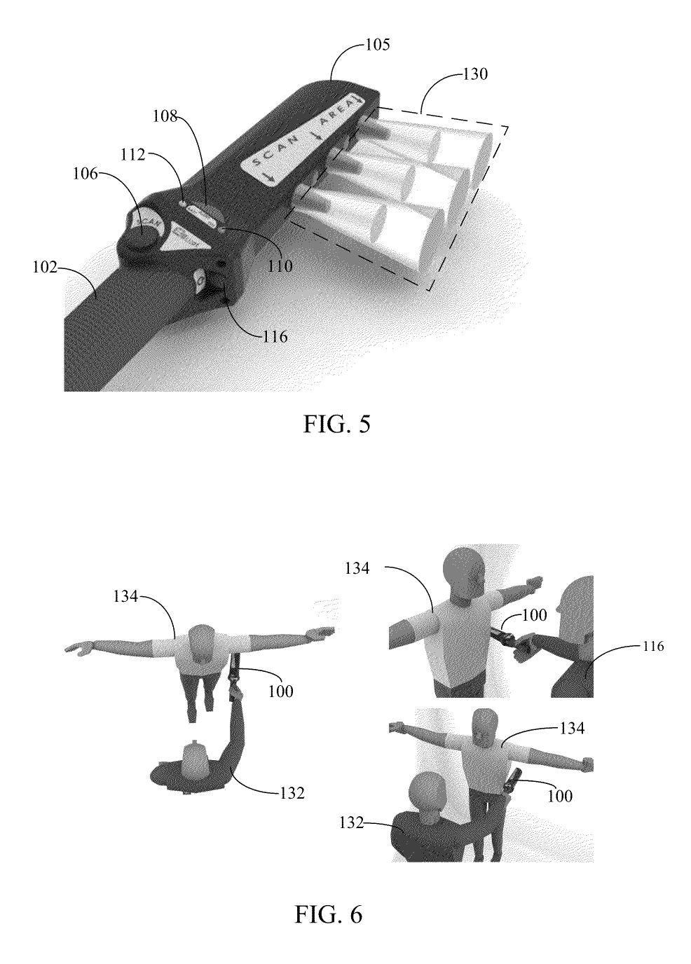

Referring now to FIG. 5, various configurations of the wand 100 are possible to define the scan area 130 with the primary tradeoff being the degree of beam collimation achieved. Cylindrically-shaped beams, which may produce more consistent results over a wider range of standoff distances, require a larger packaging volume (i.e., larger housing) that may complicate scanning between the legs. Conically-shaped beams may reduce the size of the housing, but operation over a tighter standoff range may be required for optimal performance.

The front and back torso of a body 134 may be scanned with a U-shaped motion by the operator 132 as illustrated in FIG. 6, while the arms and legs are scanned lengthwise along the top and bottom. The torso scanning requirement drives the length of the multi-pixel aperture, and determines the number of receive elements. An aperture beam extent of about 9 inches allows torso coverage with a U-shaped scan pattern. The aperture may be a linear array of independent elements. Measurements at each element may be associated with independent detections. A typical scanning approach of a body 134 using the millimeter wave energy sensing wand 100 is estimated to take 1 minute or less (assuming no alarms), according to some embodiments. It is important to note that the millimeter wave energy sensing wand 100 of embodiments does not rely on image-based detection but rather, automated, pixel-level anomaly detection may produce alarms. Therefore, the detection algorithms are substantially simpler than the algorithms operating in the WBI systems. Detection algorithms may alarm off a single-pixel intensity measurement, M-of-N element detections from a single pixel, and/or multiple pixel measurements. The detection algorithms and settings are driven by the size of the threats of interest and the associated false alarm rate for the desired detection performance.

The background millimeter wave energy value may be determined using a moving average and deviations. For example, ten readings and deviations may define a moving average that is stored as a background value. The next reading is received and compared to the background value, which is based on a moving average, to determine whether that next reading is within a standard deviation or an anomaly. If that reading is a statistically significant shift (e.g., not within the standard deviation) and is not characterized by noise, then that reading may be detected as an anomaly and may define an edge of a concealed object. In addition, a quadrupole resonance method may be used to analyze the return values of the millimeter wave energy and if altered, the values (or signature) may be compared to a library of signatures to determine whether a particular type of concealed object may have been detected.

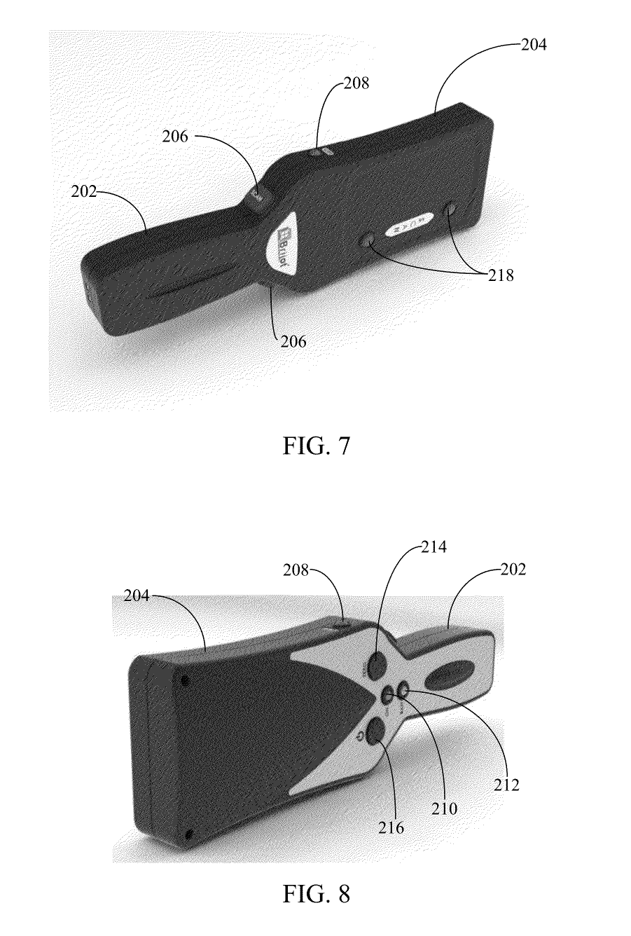

In other embodiments and referring now to FIGS. 7 and 8, the millimeter wave energy sensing wand 200 may be configured differently than shown in the preceding figures. For example, the wand 200 has a more traditional metal detector wand shape. The housing 204 is used to contain pixel(s) and other electronic components to detect millimeter wave energy emissions. A handle 202 is configured to be easily grasped by the operator as the wand 200 is passed over a body during scanning. A scan button 206 is located on the shoulder portion of the housing 204 and is used to activate the wand 200 and to begin detecting concealed objects. An alarm light 208 signals the operator visually by turning on and/or flashing when a concealed object may have been located on the body. A power light 210 is disposed on an opposing side of the housing 204 from where the scan LEDs are located. A low battery light 212 indicates when the battery needs to be recharged or a new battery installed. A power button 216 is used to switch the wand 200 on.

Prior to beginning a scan of the body, the wand 200 may be reset or zeroed using a reset button 214 on the wand 200. This provides for the wand 200 to begin processing a moving average or absolute background millimeter wave energy value of the body. Thus, when the millimeter wave energy emissions vary by a predetermined range (i.e., anomaly) from the background value, the alarm is activated. The wand 200 may generate an audible alarm if any object is detected by the wand 200. Any channel that is not positioned over the body would not be capable of generating or contributing to an audible alarm. An audible alarm with individual, channel-based LEDs identify the location of the millimeter wave anomaly on the body. LED illuminators 218 of the millimeter wave sensing wand 200 may also be used to guide the screening process to visually indicate on the body where the millimeter wave emissions indicate a possible threat.

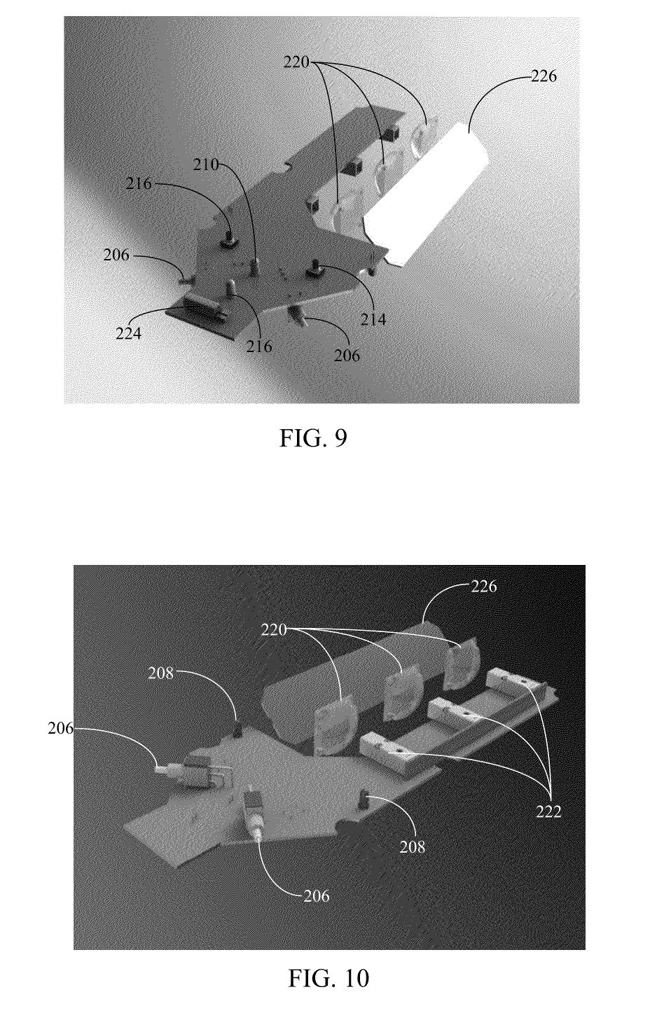

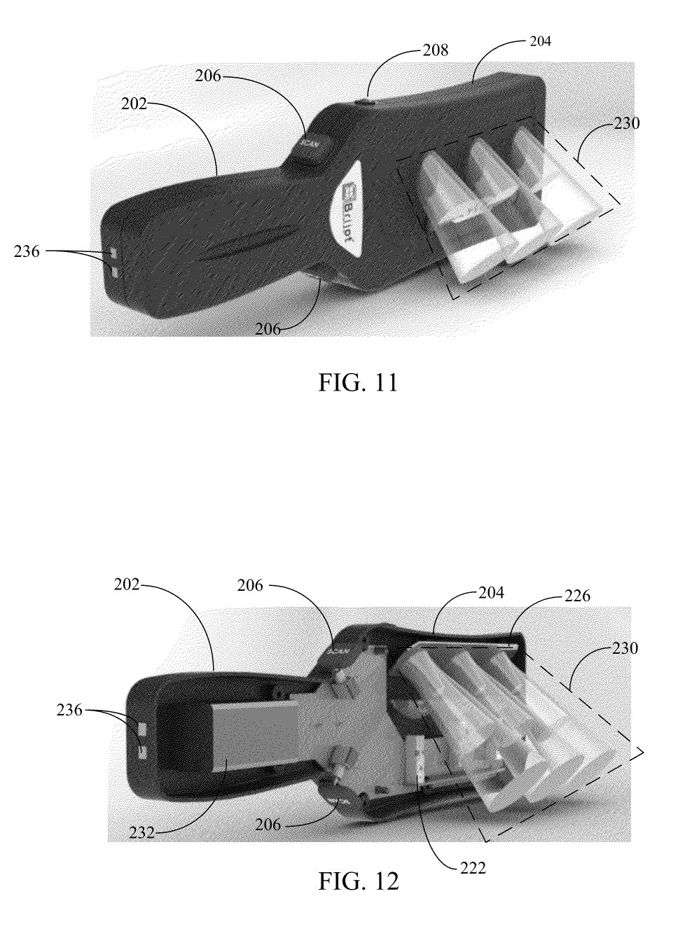

Referring now to FIGS. 9 and 10, a lens 220 may be disposed in front of each pixel 222 to focus the millimeter wave emissions. In front of the lenses 220 in embodiments such as illustrated in FIGS. 9 and 10 is an elongated mirror 224 that is used to reflect millimeter wave emissions through the lenses 120. The wand 200 may include a vibration motor 224 that is triggered by the alarm so that the operator can feel or sense when the wand 200 has detected an anomaly in the millimeter wave energy emissions, which may indicate a concealed object on the body.

Referring now to FIGS. 11 and 12, a scan area 230 of the wand 200 is illustrated. The scan area 230 may or may not be perpendicular to the housing face 204 depending on whether the pixels 222 are perpendicular within the housing 204. The width required for the pixels 222, lenses 220 and associated circuitry may require that the pixels 222 be parallel to the housing face 204, which necessitates the mirror 226 to redirect the millimeter wave emissions. A battery 232 may be contained within the handle portion 202 of the wand 200 and can be recharged through direct contacts 236 located on the bottom of the handle 202. Alternatively, the pixels 222 may be perpendicular within the housing 204.

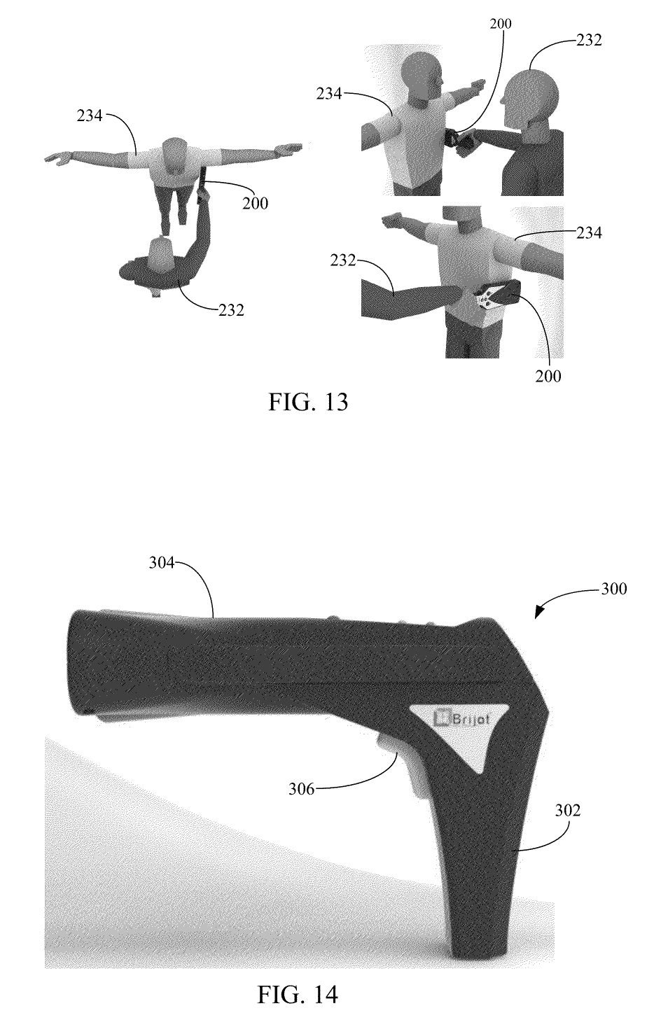

In use, the front and back torso of a body 234 may be scanned with a U-shaped motion by the operator 232 as illustrated in FIG. 13, while the arms and legs are scanned lengthwise along the top and bottom. The housing face 204 of the millimeter wave energy sensing wand 200 is moved proximate to the body 234 to detect concealed objects.

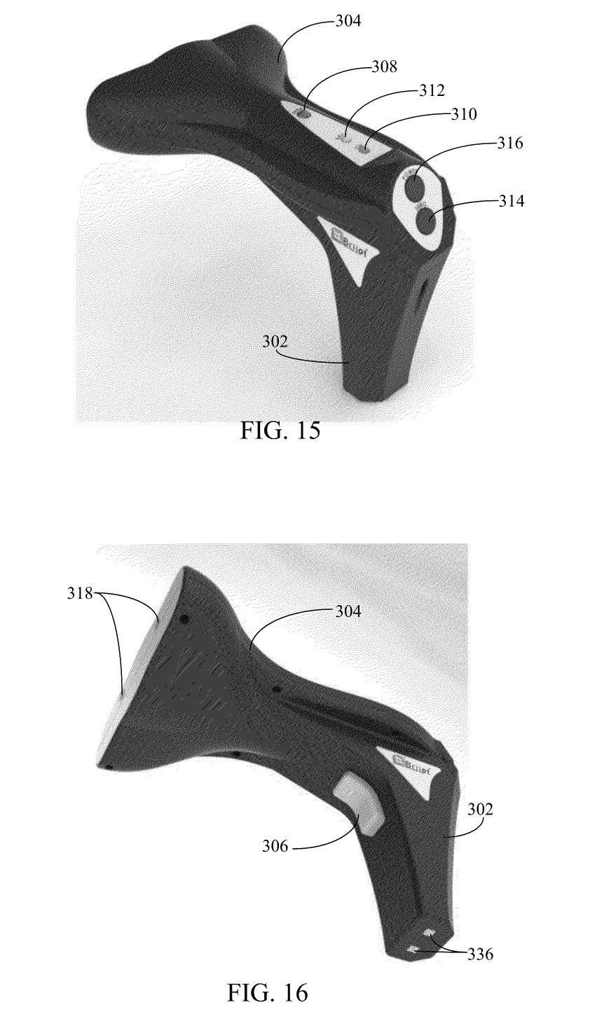

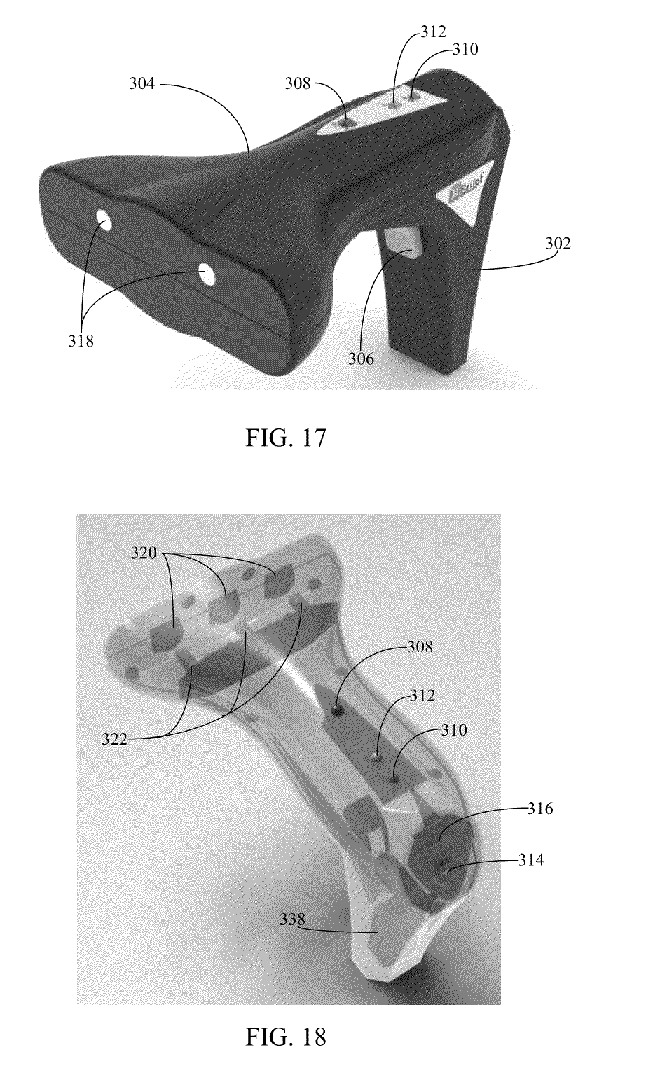

Another particular embodiment is illustrated in FIGS. 14-17, where the wand 300 has a pistol grip handle 302. The housing 304 is used to contain the pixel(s) and other electronic components to detect millimeter wave energy emissions and the operator points the wand 300 at the desired area of the body to scan. A scan button 306 is located at a trigger location on handle 302 that can be activated with an operator's index finger.

An alarm LED 308, power LED 210, and low battery LED 212 are located on a top portion of the housing 304. A pair of scan LEDs are located on a front portion of the housing 304 and illuminate the scan area 330 upon scan activation. The wand 300 may be zeroed using a reset button 314 on the wand 300 to start a new scan and set a background millimeter wave energy value of the body that may be based on a moving average or absolute value. As explained above, when the millimeter wave energy emissions vary by a predetermined range from the background value, the alarm is activated. The wand 300 may generate an audible alarm if any object is detected by the wand 300.

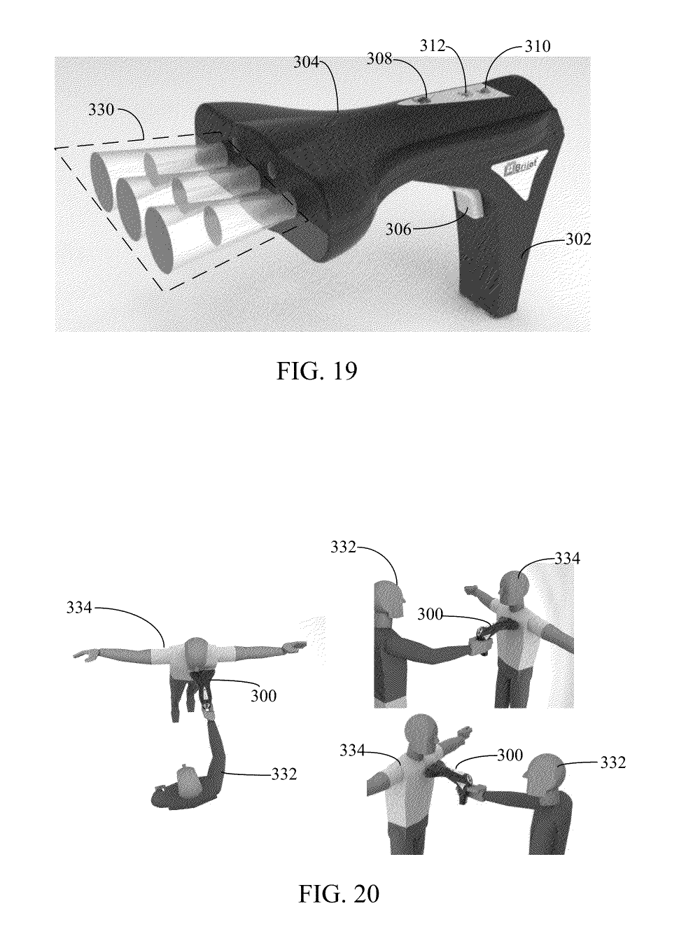

Referring now to FIG. 18, a lens 320 may be disposed in front of each pixel 322 to focus the millimeter wave emissions. The wand 300 may include a vibration motor 324 that is triggered by the alarm so that the operator can feel or sense when the wand 300 has detected an anomaly in the millimeter wave energy emissions, which may indicate concealed contraband on the body. A battery 338 may be contained within the handle portion 302 of the wand 300 and can be recharged through direct contacts 336 located on the bottom of the handle 302. The scan area 330 of the wand 300 is illustrated in FIG. 19.

The front and back torso of a body 334, similarly as discussed above, may be scanned with a U-shaped motion by the operator 332 as illustrated in FIG. 20, while the arms and legs may be scanned lengthwise along the top and bottom. The millimeter wave energy sensing wand 300 is moved proximate to the body 334 to detect concealed objects.

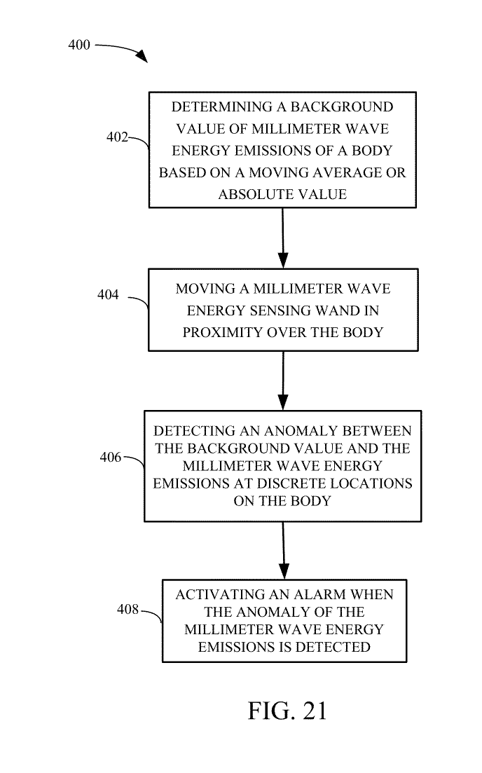

Referring now to FIG. 21, a particular illustrative embodiment of a millimeter wave energy sensing method is disclosed and generally designated 400. A background value of millimeter wave energy emissions of a body is determined, at 402, that may be a moving average value or an absolute value. A millimeter wave energy sensing wand is moved, at 404, in proximity over the body. At 406, an anomaly between the background value and the millimeter wave energy emissions at discrete locations on the body are detected. The anomaly may be detected when a predefined or selected amount of millimeter wave energy appears to be blocked (or reduced to an amount or value) that may indicate a concealed object on the body. An alarm is activated when the anomaly of the millimeter wave energy emissions is detected, at 408.

Embodiments such as described above may include a millimeter or terahertz handheld sensing device that operates using passive reception of millimeter or terahertz waves to identify potential concealed objects within the sensing area. Such passive devices provide sensing capabilities without the need to generate energy that is to be provided to the sensing area and be reflected back to the sensor. In other sets of embodiments, a millimeter or terahertz wave sensing device may operate in two or more sensing modes, including both a passive and an active sensing mode. Sensing modes may also include a metal detection sensing mode and a proximity sensing mode.

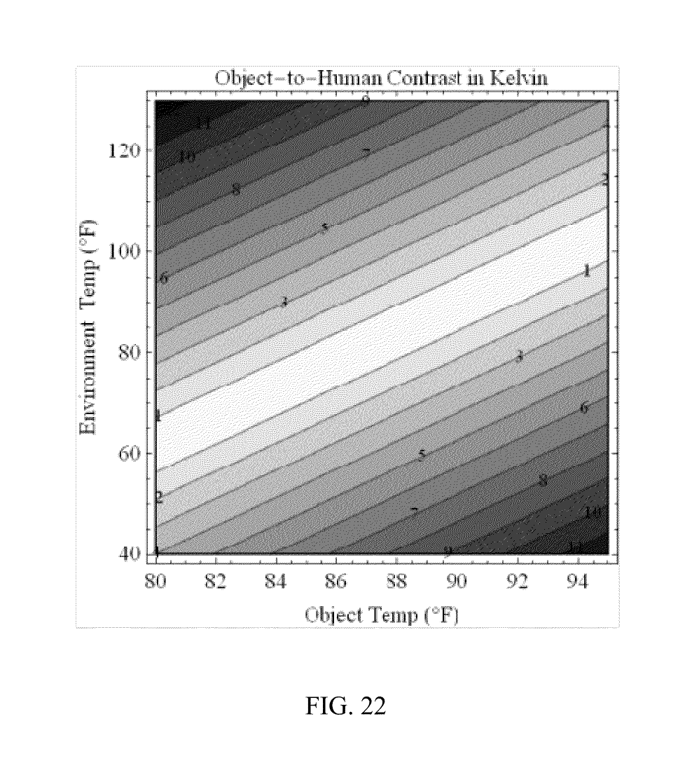

The addition of other sensing modes allows for enhanced object detection for scanners according to such further sets of embodiments, which may be useful for certain applications in which sensing devices may be used. In some embodiments, one or more active sensing modes may detect reflections from objects having a temperature that is substantially the same as the temperature of the body being scanned. In such situations, passive object detection is challenged due to insufficient MMW intensity contrast between the subject and the concealed object. This condition may result, for example, when a dielectric (non-metallic) object obtains a “brightness” similar to that of the human subject on whom the object is located. Brightness is a combination of emissivity (energy emitted) and temperature of an object. When the brightness of the object is too similar to the brightness of a person, a resulting lack of intensity contrast, is referred to as a thermal “dead-band.” A modeled representation of this dead-band is shown in FIG. 22. As can be seen from this figure, this dead-band may be observed as the central-most white region, and has a thermal width of about 2 Kelvin for an object's temperature given a constant environment and human temperature.

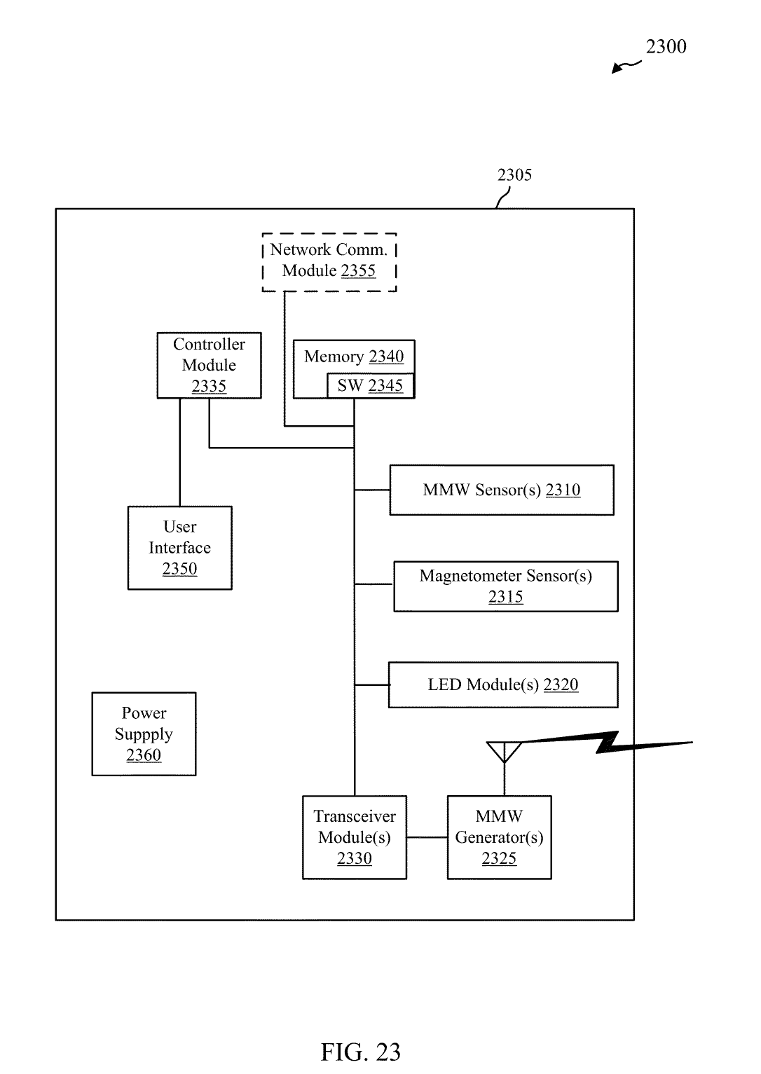

In some embodiments, in order to improve object detection, particularly with respect to the dead-band, sensing devices include sensors that have relatively high thermal sensitivity, which will have the effect of reducing the thermal width of the dead-band. In some embodiments, sensors also employ active detection schemes in addition to passive detection schemes. Such active detection may be used while maintaining passive MMW detectability, and may be used to address on dead-band object detection. In these embodiments, an active MMW source and detector combination may be used to assess reflectivity differences over the scanned field of view (FOV). FIG. 23 illustrates a block diagram of a MMW sensing device 2300 according to some embodiments. The MMW sensing device 2300 of embodiments includes a housing 2305 that includes a number of components and is capable of stand-alone object detection. The housing 2305 of some embodiments includes a handle portion and a sensing or wand portion, similarly as described above, that may be moved in proximity to a body that is being scanned. Within the housing 2305 are a plurality of sensors, including MMW sensor(s) 2310, and magnetometer sensor(s) 2315, in this embodiment. The housing 2305 may include one or more LED modules 2320 having one or more light emitting diodes that may illuminate a sensing area to provide a visual indication to an operator of the device 2300 of the area being scanned. In some embodiments, separate MMW sensors 2310 each have an associated LED module 2320, which may provide a visual indication of the scanning area associated with each MMW sensor 2310. In some embodiments, each MMW sensor 2310, also referred to as a pixel, includes a monolithic microwave integrated circuit packaged into an RF cavity with a stub antenna.

As mentioned above, the device 2300 may provide MMW sensing in both active and passive modes. Active detection is provided by activating one or more millimeter or terahertz wave generator(s) 2325 through transceiver module(s) 2330, responsive to a command output by a controller module 2335. The millimeter or terahertz wave generator 2330 may act to irradiate the scan area in order to generate reflections from objects, which may be detected through one or more various techniques, such as edge detection techniques. The device 2300 operating with both passive and active detection may allow detection of objects, both metallic and non-metallic, and regardless of material type or temperature. In some embodiments, the MMW generator 2325 irradiance is designed to be at least 100 times that of the blackbody radiation from the subject that is being scanned. Such a difference in irradiance may allow detection of objects within the dead-band, by inducing reflections from any such objects that may be picked up by MMW sensor(s) 2310. Controller module 2335 is electronically coupled with the MMW sensor(s) 2310, magnetometer sensor(s) 2315, LED module(s) 2320, and transceiver module(s) 2330. Controller module 2335 may include components that allow for analysis of the signals from the sensors 2310, 2315, to identify potential concealed objects within the scan area, as will be described in more detail below. In some embodiments, controller module 2335 is configured to detect objects based upon the ability to detect differences in the reflectance of the object and its edges compared to the subject, making use of the time fluctuation of the returned signal. A memory module 2340 is coupled with the controller module 2335, and may include random access memory (RAM) and read-only memory (ROM). The memory module 2340 may also store computer-readable, computer-executable software code 2345 containing instructions that are configured to, when executed, cause the controller module 2335 to perform various functions described herein (e.g., processing of signals from sensor modules 2310, 2315 identification of potential concealed objects, etc.). Alternatively, the software code 2345 may not be directly executable by the controller module 2335 but be configured to cause the controller 2335, e.g., when compiled and executed, to perform functions described herein.

The controller module 2335 may include an intelligent hardware device, e.g., a central processing unit (CPU) such as those made by Intel® Corporation or AMD®, a microcontroller, an application-specific integrated circuit (ASIC), etc. The controller module 2335, in the embodiment of FIG. 23, is coupled with a user interface 2350, which an operator may access to operate the device 2300, such as buttons, indicators, alarm feedback, and/or display as described above. The device 2300 may also optionally include a network communication module 2355 that may communicate with one or more other networked components through a wired or wireless connection. Finally, a power supply 2360 may provide operating power to the device 2300. In some embodiments, power supply 2360 includes a rechargeable battery pack and/or an input for external power to be supplied to the device 2300 to provide operating power and/or recharging of a battery pack. In embodiments where the power supply 2360 may be used to recharge a battery pack, appropriate charging circuitry and/or charge controllers are included in the power supply 2360. In some embodiments, the power supply 2360 may include one or more swappable battery packs, thereby providing a portable device with a self-contained power supply that is easily interchanged to provide flexible and continuous use in operations.

Components of MMW sensing device 2300 may, individually or collectively, be implemented with one or more application-specific integrated circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific processors. Each of the noted modules may be a means for performing one or more functions related to operation of the MMW sensing device 2300.

As discussed, the MMW sensing device 2300 may operate using two or more sensing modes, and in some embodiments operates using three sensing modes, namely passive MMW sensing, active MMW sensing, and metal sensing responsive to magnetometer sensor 2315. The combination of three sensing modalities may serve as input into an object detection algorithm executed by controller module 2335. This combination of modalities will create parametric areas of overlapping, complementary detections that will serve to strengthen the confidence of detections. Additionally, such operation may create parametric regions between these modalities that do not overlap, thereby extending detection performance capabilities beyond that of a sensing device that operates using solely passive MMW detection, or operates using only metal detection. The result of these object detection improvements will be an increase in probability of detection (P_{d}) and a decrease in probability of false alarm (P_{fa}), particularly with respect to the aforementioned thermal deadband.

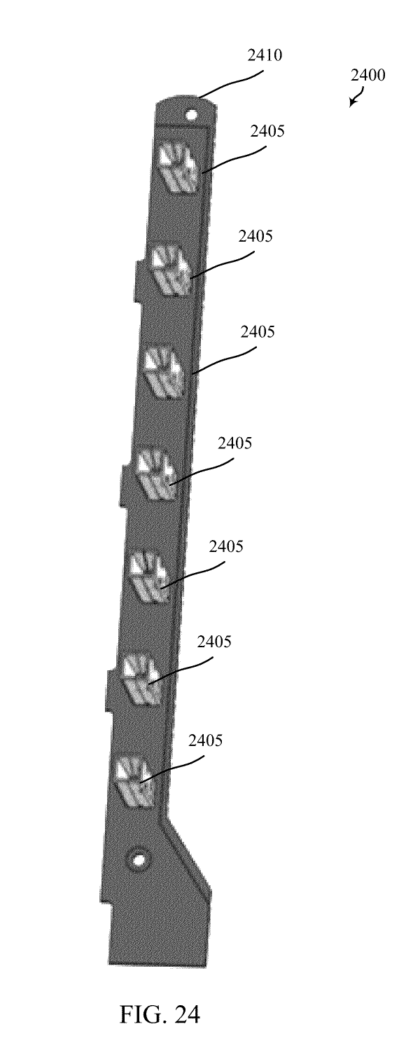

In one embodiment, illustrated in FIG. 24, a handheld MMW sensing device includes a sensing module 2400 that includes seven MMW sensors 2405 mounted of a circuit board 2410. Each MMW sensor 2405, similarly as discussed above, may include a monolithic microwave integrated circuit packaged into an RF cavity with a stub antenna. In some embodiments, each MMW sensor 2405 contains a sensor portion and a source portion. The sensor portion receives MMW radiation, and the source portion may generate MMW radiation. The source portion according to some embodiments may include a coherent or incoherent radiation source, such as a Gunn diode and/or IMPATT diode, for example.

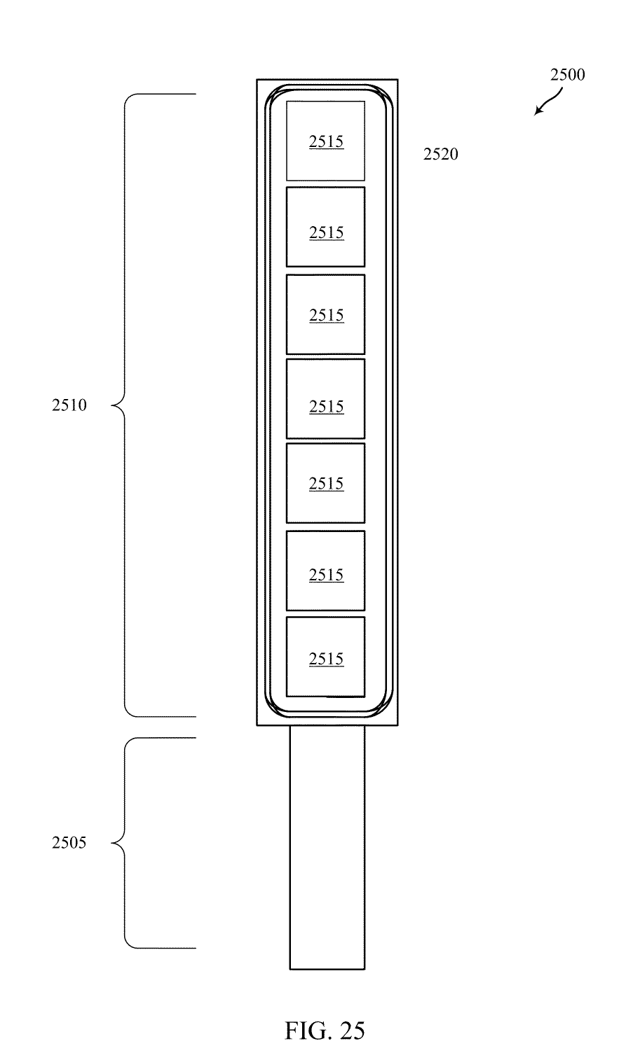

Metal detection may be provided in embodiments through one or more magnetometer sensors, as discussed above. Threat objects, such as Improvised Explosive Devices (IEDs), may contain small amounts of metallic components (i.e., wires), which may present a challenge when using only MMW technology for detection, but which may be more readily detected using a magnetometer sensor. FIG. 25 is a block diagram illustration to an MMW sensing device 2500 that includes a magnetometer sensor. The MMW sensing device 2500 of this embodiment includes a housing with a handle portion 2505 and a wand portion 2510. Within the wand portion 2510, are MMW sensing apertures 2515, as well as magnetometer source and pickup coils 2520. The magnetometer source and pickup coils 2520 of this embodiment extend around the perimeter of the wand portion 2510, and may be coupled with a controller, such as controller module 2335 of FIG. 23 to provide an indication of metal detection using known metal detection techniques. In one embodiment, a very low frequency (VLF) type metal detector is used to achieve metal detection performance equivalent to the ubiquitous handheld metal detectors. This may help extend the P_{d} performance for metallic objects of decreasing size. The field of view for the magnetometer source and pickup coils 2520 in embodiments substantially matches the field of view for the MMW sensors within MMW sensing apertures 2515. This may be achieved through placement of the magnetometer source and pickup coils 2520 around the MMW sensor apertures 2515. In embodiments, the metal detection circuit operates according to a VLF scheme that is calibrated to compensate for the interaction of the other metallic device components, such as the MMW sensors, within the device 2500.

As mentioned above, MMW sensing devices according to various embodiments may include proximity detection to provide feedback to an operator to indicate if the device is within a predefined proximity of the body being scanned. In some embodiments, separate proximity sensors are associated with MMW sensing modules and operate at 850 nanometers near-infrared (NIR), just past the visible spectrum, using a Light Emitting Diode (LED) source. Such proximity detectors provide a distance to the surface of clothing on an individual but, because this wavelength does not penetrate clothing, the detectors are unable to determine the distance to the surface of the body if clothing is covering that portion of the body, which is an important parameter to the detection algorithm. In other embodiments, a proximity sensor is used that operates at millimeter wavelengths. This type of proximity sensor may allow for a more precise distance measurement to the body surface, thus increasing the probability of detection and reducing the occurrence of false alerts. The method for implementing such a proximity sensor is similar to that of a NIR proximity sensor, wherein the absolute magnitude of the emitted and/or reflected energy from the subject is analyzed to indicate the distance to the skin surface, and is known to those skilled in the art, and is taught inter-alia in U.S. Pat. No. 5,600,253 issued Feb. 4, 1997 to Cohen et al, the entire contents of which is incorporated herein by reference.

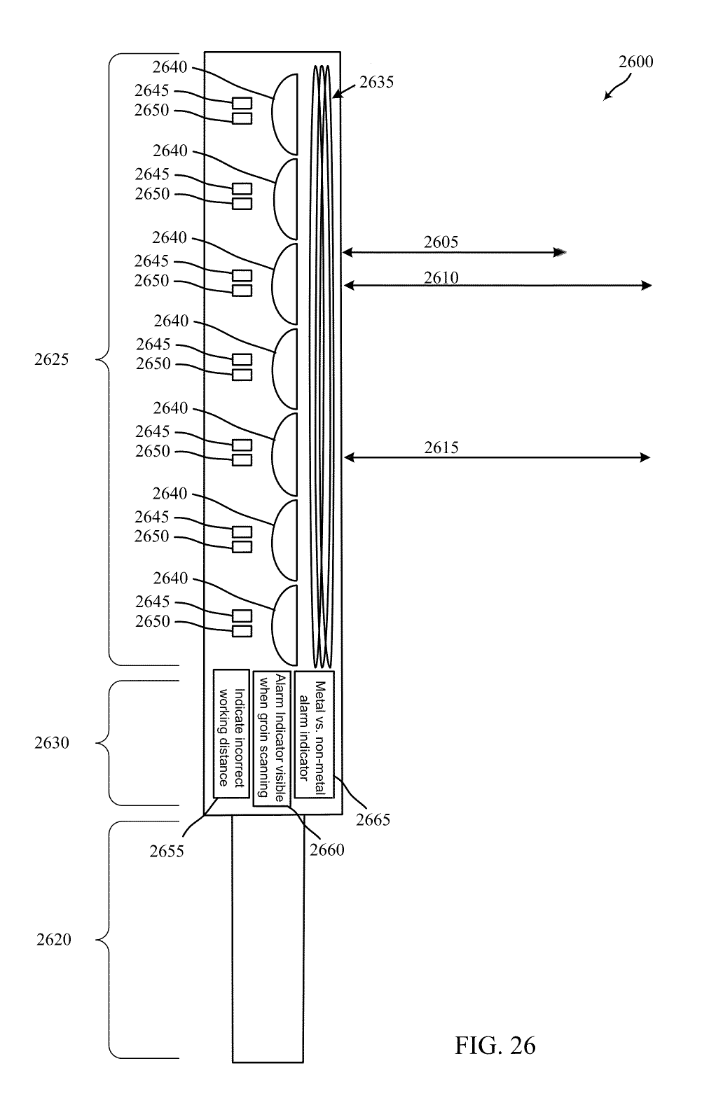

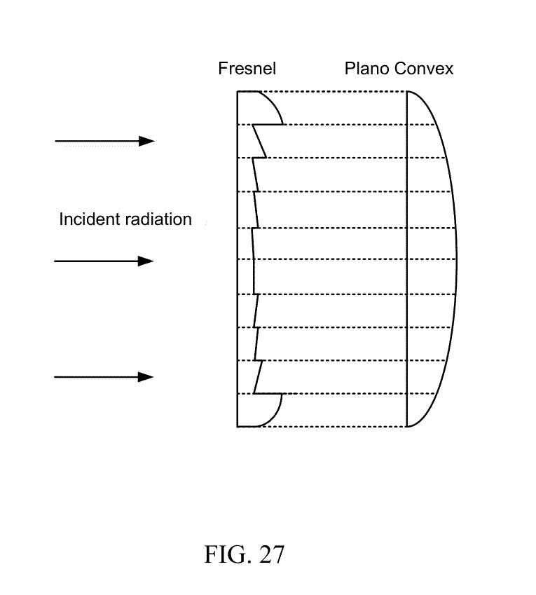

Operating distances of such handheld sensing devices are often desired to be within six inches from the subject being scanned. In many embodiments a passive MMW sensing device, such as described with respect to the embodiments of FIGS. 1-21, has a reliable operating range of about 4 inches from the surface of the skin of a subject that is being scanned. Use of such devices outside of this working range may result in decreased sensitivity and potentially an increased number of false detections. However, providing a working distance of greater than four inches may provide greater ease of use for the operator, particularly while scanning the groin area of a subject that is being scanned. FIG. 26 illustrates an embodiment of a MMW sensing device 2600 which may employ a six inch working range. FIG. 26 shows a four inch working range 2605, a six inch working range 2610, and a working range of a proximity detector 2615. The MMW sensing device 2600 uses the three sensing modes (magnetometer, passive and active MMW), to achieve a working range, according to some embodiments, of up to six inches from a scanned surface. According to some embodiments, such as illustrated in FIG. 26, a MMW sensing device 2600 may require a positive object detection from two or more of the sensing modes, such as through a logical AND, prior to indicating the presence of an object in the sensing area. In such a manner, increased numbers of false detections generated from a passive MMW mode may be mitigated through a logical AND with detections generated from an active MMW mode, thus providing an increased working range with reliable detection of concealed objects. In some embodiments, the MMW sensing device 2600 includes a housing with a handle portion 2620, a wand portion 2625, and a user interface portion 2630. Within the wand portion 2625 are magnetometer source and pickup coils 2635 which may, similarly as discussed above, extend around MMW sensing apertures. In the embodiment of FIG. 26, MMW sensing apertures include a lens 2640, an MMW source 2645, and an MMW receiver 2650. Lens 2640 has a lens aperture that is adapted to provide a relatively small collection area at a six inch working distance from the scanned area. In some embodiments, in order to provide a lower device weight, a two- or three-zone Fresnel lens design may be used, as shown in FIG. 27.

With continuing reference to FIG. 26, user interface portion 2630 may include a number of user interface devices. For example, a number of buttons may be provided, similarly as described above, to initiate scanning, reset the device, power the device on and off, etc. User interface portion 2630 of FIG. 26 also includes a number of indicators including a proximity indicator 2655, an alarm indicator 2660 that may indicate an object detected, and a metal versus non-metal indicator 2665. These indicators may be configured in an array or in a row of indicators with specific elements in the array or row corresponding to a sensor location within the wand portion 2625. In some embodiments, a display may be provided that displays such information. Such visual parts of user interface portion 2630 help to indicate the size and location of the object because each light corresponds with a particular MMW sensor. In some embodiments, one or more lights may project indicating lights or patterns onto the subject during the scan. These lights may serve two purposes: 1) to indicate the presence of an anomalous object and, 2) to indicate the scanned field of view of the MMW sensors. This projection feature may allow for enhanced operator feedback and knowledge regarding the precise location of potential threat objects, as well as help support the operator's screening technique.

The user interface portion 2630 may also assist operators in proper scanning by providing audible and/or visual cues that indicate when the device is not at the proper distance from the subject and/or if the operator is moving the sensing device 2600 too quickly over the subject being scanned. In some embodiments, this feedback may be accomplished by using MMW proximity sensor data along with a motion sensor also located in the device. Proximity sensing according to some embodiments may be accomplished based on signals from MMW receivers 2650, and signal strength of received signals when the MMW sensing device 2600 is below a threshold level when operating in active MMW sensing mode. In some embodiments, information from a motion sensor, such as a six axis gyroscope and motion sensor, for example, may be used to determine if the MMW sensing device 2600 has been moved more than a particular distance in a particular direction or is being moved too quickly over the subject to provide reliable scanning. Additionally, to help better identify the type of object detected an operator feedback may be provided that classifies detected objects into either metallic or non-metallic categories using visual cues. For example, a different color alarm LED for each threat type may be used. In some embodiments, a text display may be used to communicate the classification of threat present.

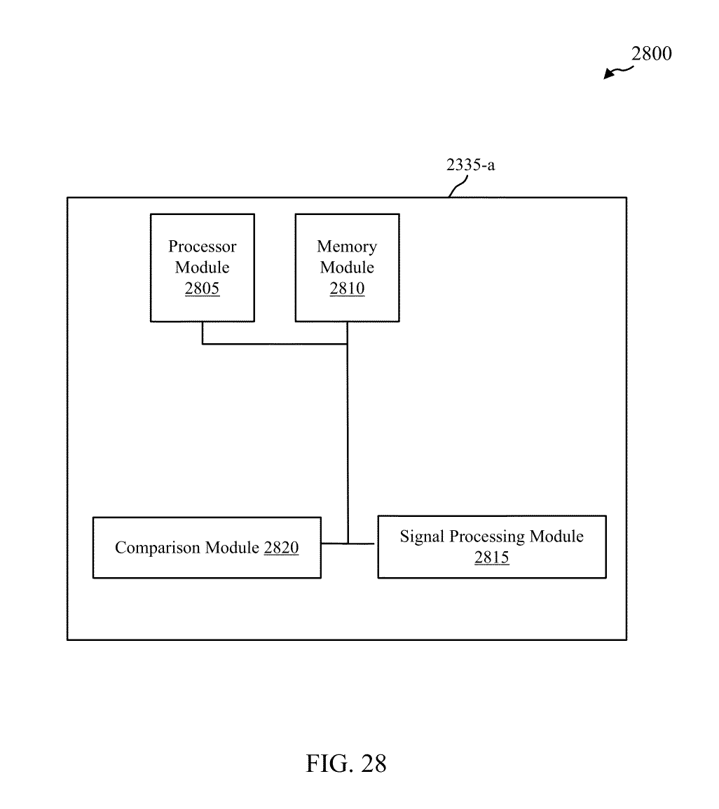

With reference now to FIG. 28, a block diagram 2800 of a controller module 2335-a according to some embodiments is described. As discussed with respect to FIG. 23, controller module 2335-a may be coupled with different sensors of the MMW detection device, as well as to other modules within the device. The controller module 2335-a of FIG. 28 includes a processor module 2805, memory module 2810, a signal processing module 2815, and a comparison module 2820. Components of controller module 2335-a may, individually or collectively, be implemented with one or more application-specific integrated circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific processors. Each of the noted modules may be a means for performing one or more functions related to operation of the controller module 2335-a.

The signal processing module 2815 may receive and process signals from the millimeter or terahertz wave energy sensor(s), such as MMW receiver 2650, to determine energy values associated with the sensor. Memory module 2810 may be configured to store background energy values associated with the body. Such energy values may be preset to be within a default range of values, or may be acquired during initial scanning operations. Comparison module 2820 may be configured to compare energy values from the sensing area to the background energy values. In embodiments, the comparison module 2820 detects an anomaly and provides information to processor module 2805 to generate feedback to the operator when an anomaly is detected in the energy values.

Various different detection schemes may be used to determine whether an anomaly detected, which may be reported to the operator through operator feedback. Such detection schemes may include sequentially activating and deactivating MMW sources (e.g., MMW sources 2645 of FIG. 26), and switching a gain of an associated MMW receiver (e.g., MMW receivers 2650 of FIG. 26) from a passive gain setting to an active gain setting. In such embodiments, each source/receiver combination noperates in a passive detection mode when the MMW source is off, and in an active detection mode when the MMW source is on. For example, if a MMW sensing device includes seven MMW source/receiver pairs, the each would operate in active mode one-seventh of the time, and in passive mode six-sevenths of the time. In passive mode, anomaly detection may be accomplished as discussed above, such as, for example, through detection of differences from background readings or an average of prior readings. In active mode, anomaly detection may be accomplished through a comparison of received signal samples, with a relatively large jump in signal strength indicating an anomaly that may be an object, and/or ringing in received signals (through constructive/destructive interference) that may indicate an edge of an object. In a metal detecting mode, magnetometer source coil may be activated, with differences in the pickup coil monitored to determine the presence of an anomaly. In some embodiments, operator feedback indicating an anomaly is generated when two or more of the sensing modes indicate an anomaly. For example, if an anomaly is detected in both the passive and active MMW sensing modes, but not in the metal detection mode, feedback maybe provided to an operator that a non-metallic object has been detected. Similarly, if an anomaly is detected with the metal detector and in one of the active or passive sensing modes, feedback maybe provided to an operator that a metallic object has been detected. In some embodiments, operator feedback is provided that indicates which of the source/receiver pairs is associated with the object detection.

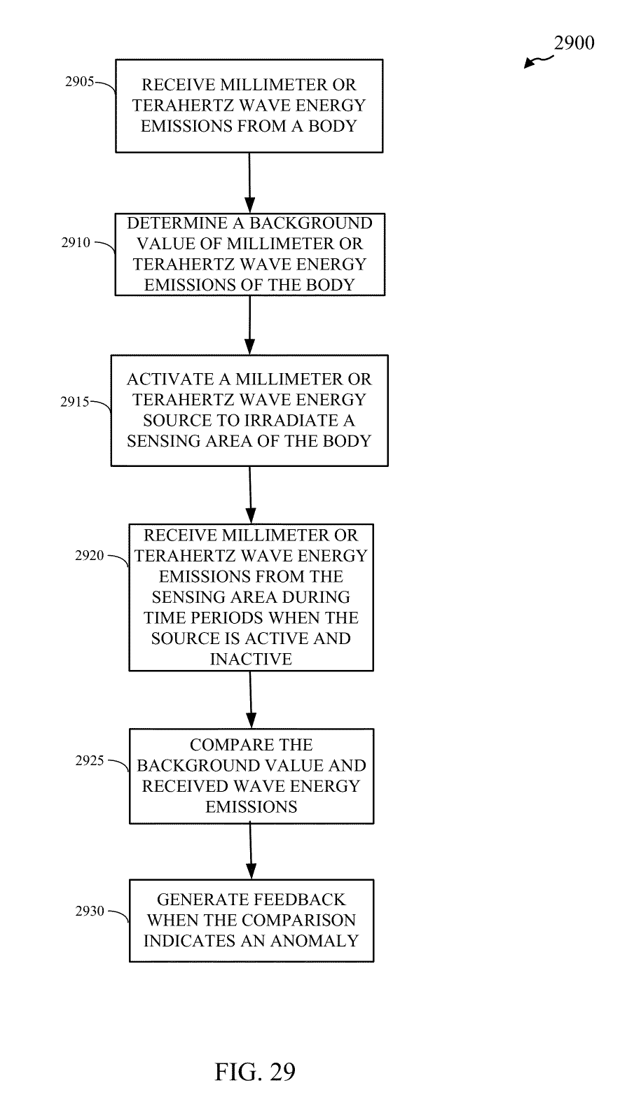

With reference now to FIG. 29, a flow chart illustrating one example of a method 2900 for concealed object detection is discussed. For clarity, the method 2900 is described below with reference to a MMW sensing device such as shown in FIGS. 23 through 28. In one implementation, the controller module 2335 of FIG. 23, or the controller module 2335-a of FIG. 28, may execute one or more sets of codes to control the functional elements of the MMW sensing device to perform the functions described below.

Initially, at block 2905, millimeter or terahertz wave energy emissions are received from a body. A background value of millimeter or terahertz wave energy emissions of the body is determined, at block 2910. At block 2915, a millimeter or terahertz wave energy source is activated to irradiate a sensing area of the body. Millimeter or terahertz wave energy emissions from the sensing area are received during time periods when the source is active and inactive, according to block 2920. The background value and the millimeter or terahertz wave energy emissions at the sensing area are compared at block 2925. Finally, at block 2930, an operator feedback is generated when the comparing indicates an anomaly in the millimeter or terahertz wave energy emissions at the sensing area. In some embodiments, as discussed above, signals may also be received from a magnetometer coupled with the handheld detector, with operator feedback generated when the signals from the magnetometer indicate the presence of a metallic object at the sensing area. In still further embodiments, a proximity may be determined between the handheld detector and the sensing area based on the millimeter or terahertz wave energy emissions from the sensing area, with operator feedback generated when the proximity is outside of a predetermined proximity limit.

The detailed description set forth above in connection with the appended drawings describes exemplary embodiments and does not represent the only embodiments that may be implemented or that are within the scope of the claims. The term “exemplary” used throughout this description means “serving as an example, instance, or illustration,” and not “preferred” or “advantageous over other embodiments.” The detailed description includes specific details for the purpose of providing an understanding of the described techniques. These techniques, however, may be practiced without these specific details. In some instances, well-known structures and devices are shown in block diagram form in order to avoid obscuring the concepts of the described embodiments.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the spirit or scope of the disclosure. Throughout this disclosure the term “example” or “exemplary” indicates an example or instance and does not imply or require any preference for the noted example. Thus, the disclosure is not to be limited to the examples and designs described herein but is to be accorded the widest scope consistent with the principles and novel features disclosed herein.

What is claimed is:

1. A concealed object detection apparatus, comprising:
a housing comprising a handle adapted to be grasped by an operator to facilitate movement of the housing proximate to a sensing area on a body;
a plurality of sensors coupled with the housing comprising at least one millimeter or terahertz wave energy sensor; and
a controller coupled with the housing and electrically coupled with the plurality of sensors, the controller configured to receive signals from the plurality of sensors in two or more sensing modes, including an active sending mode and a passive sensing mode, and generate feedback when an anomaly is detected in the received signals.

2. The apparatus of claim 1, wherein the two or more sensing modes further include a metal detection sensing mode.

3. The apparatus of claim 1, further comprising a millimeter or terahertz wave source coupled with the housing and electrically coupled with the controller, and wherein the millimeter or terahertz wave source is activated in the active sensing mode and deactivated in the passive sensing mode.

4. The apparatus of claim 1, wherein the plurality of sensors further comprise a magnetometer sensor, and wherein the two or more sensing modes further include a metal detection sensing mode responsive to the magnetometer sensor.

5. The apparatus of claim 4, wherein the controller is further configured to generate operator feedback based on signals from the magnetometer sensor and the at least one millimeter or terahertz wave energy sensor.

6. The apparatus of claim 1, further comprising a lens coupled with the housing and configured to focus the millimeter or terahertz wave energy to the at least one millimeter or terahertz wave energy sensor.

7. The apparatus of claim 6, wherein the lens comprises a Frensel lens.

8. The apparatus of claim 1, wherein the controller is further configured to determine a proximity between the plurality of sensors and the sensing location based on signals from the at least one millimeter or terahertz wave energy sensor.

9. The apparatus of claim 1, further comprising one or more light emitting diodes (LEDs) to visually illuminate the sensing area.

10. The apparatus of claim 1, wherein the controller comprises:
a signal processing module that receives and processes signals from the at least one millimeter or terahertz wave energy sensor to determine energy values associated with the sensor;
a memory module configured to store background energy values associated with the body; and
a comparison module for comparing energy values from the sensing area to the background energy values and generate feedback when an anomaly is detected in the energy values.

11. A method for concealed object detection with a handheld detector, comprising:
receiving millimeter or terahertz wave energy emissions from a body;
determining a background value of millimeter or terahertz wave energy emissions of the body;
activating a millimeter or terahertz wave energy source to irradiate a sensing area of the body;
receiving millimeter or terahertz wave energy emissions from the sensing area;
comparing the background value and the millimeter or terahertz wave energy emissions at the sensing area; and
generating operator feedback when the comparing indicates an anomaly in the millimeter or terahertz wave energy emissions at the sensing area.

12. The method of claim 11, further comprising:
receiving signals from a magnetometer coupled with the handheld detector; and
generating operator feedback when the signals from the magnetometer indicate the presence of a metallic object at the sensing area.

13. The method of claim 11, wherein the receiving millimeter or terahertz wave energy emissions from the sensing area comprises:
receiving passive millimeter or terahertz wave energy emissions from the sensing area before activating the a millimeter or terahertz wave energy source; and
receiving active millimeter or terahertz wave energy emissions from the sensing area while the a millimeter or terahertz wave energy source is activated, and
wherein the comparing further comprises comparing the background value, the passive energy emissions, and the active energy emissions.

14. The method of claim 11, further comprising:
determining a proximity between the handheld detector and the sensing area based on the millimeter or terahertz wave energy emissions from the sensing area; and
generating operator feedback when the proximity is outside of a predetermined proximity limit.

15. The method of claim 14, wherein the predetermined proximity limit is between approximately one inch (25.4 mm) and six inches (152.4 mm).

16. The method of claim 11, further comprising:
illuminating the sensing area with visible light from the handheld detector.

17. A handheld apparatus for concealed object detection, comprising:
means for determining a background value of millimeter or terahertz wave energy emissions of a body;
means for irradiating a sensing area of the body with millimeter or terahertz wave energy;
means for receiving millimeter or terahertz wave energy emissions from the sensing area;
means for comparing the background value and the millimeter or terahertz wave energy emissions at the sensing area; and
means for generating operator feedback when the comparing indicates an anomaly in the millimeter or terahertz wave energy emissions at the sensing area.

18. The apparatus of claim 17, further comprising:
means for determining the presence of a metallic object at the sensing area.

19. The apparatus of claim 17, further comprising:
means for determining a proximity between the handheld apparatus and the sensing area based on the millimeter or terahertz wave energy emissions from the sensing area; and
means for generating operator feedback when the proximity is outside of a predetermined proximity limit.

20. The apparatus of claim 17, further comprising:
means for focusing millimeter or terahertz wave energy emissions from the sensing area on a millimeter or terahertz wave energy sensor.
